(19) United States
(12) Patent Application Publication
(10) Pub. No.: US 2008/0311924 A1
(43) Pub. Date: Dec. 18, 2008

(54) Method for Allocating Communication Resources and Radiocommunication System Therefor

(76) Inventor: Thierry Lucidarme, Montigny Le Bretonneux (FR)

Correspondence Address: SUGHRUE MION, PLLC, 2100 PENNSYLVANIA AVENUE, N.W., SUITE 800, WASHINGTON, DC, 20037, US

(21) Appl. No.: 10/585,428

(22) PCT Filed: Jan. 3, 2005
(86) PCT No.: PCT/EP05/00006

§ 371 Date: Sep. 2, 2008

(51) Int. Cl. H04Q 7/20; H04Q 7/22; H04Q 7/38

(52) U.S. Cl. 455/452.1; 370/335; 370/337; 455/453

(57) ABSTRACT

A method of allocating communications resources in a radio communications system comprising a first subsystem (1) and a second subsystem (2) using different radio access techniques and adapted to communicate with radio terminals (3). The method comprises the following steps:

determining an indication about the occupancy of the communications resources of said first and/or said second subsystem, and

when a call is to be set up for a radio terminal, allocating a communications resource of the first or second subsystem to the call taking account of the indication so determined.

The present invention relates to allocating communications resources in a heterogeneous radio communications system. It relates more particularly to allocating communications resources of one of several subsystems of the radio communications system that use different radio access techniques.

It is known that radio communication performance is strongly linked to the radio access technique used. For example, in the time division multiple access (TDMA) technique the communications resources are separate time slots on channels having a given frequency. In the CDMA (code division multiple access) technique, the data to be transmitted is modulated by quasi-orthogonal codes known to the sender and to the receiver.

When a radio communications system comprises different subsystems using different radio access techniques, the question of traffic distribution may arise. It is desirable to distribute traffic between the subsystems as a function of the performance that they offer to obtain the best possible performance. It is also desirable to distribute traffic between the subsystems so that the traffic in the system as a whole can be maximized.

That situation may arise in the context of a mixed radio communications network comprising a second generation (2G or 2.5G) subsystem, such as the GSM (Global System for Mobile communication), where applicable expanded by incorporating the GPRS (General Packet Radio Service) data packet transmission standard, and a third generation (3G) subsystem, such as the UMTS (Universal Mobile Telecommunication System). Assigning a dual mode (2G and 3G) radio terminal to one of the two subsystems can then be prioritized to optimize communication quality.

It should first be noted that traffic distribution in that kind of mixed system is not a simple matter and cannot be clearly envisaged by a person skilled in the art because mobile terminals are attached to one of the subsystems before they begin to communicate. It is therefore natural for a call to be set up on the subsystem to which the terminal is attached, and how to modify that kind of attachment is not obvious, such attachment being generally exclusively at the initiative of the mobile terminals, at least in some systems adapted to transmit data.

Assuming that that kind of obstacle can be removed, one widely accepted idea is to distribute traffic in that kind of system as a function of the type of calls to be provided. For example, the first priority is often to assign voice calls to the 2G subsystem and data packet transmission to the 3G subsystem. Fallback to the other subsystem is available only if the first priority subsystem is saturated. That kind of distribution is based in particular on the idea that each subsystem is better adapted to implement a given service.

It has been found that that kind of distribution is less than the optimum because it ignores the real performance of the subsystems resulting from their different radio access techniques and/or their respective spectra. For example, a 2G or 2.5G subsystem conventionally has a wider spectrum (up to 75 MHz in the 1800 MHz frequency band) than a 3G subsystem (conventionally less than 15 MHz in 3G networks in Europe). For these reasons, the wisdom of systematically assigning packet mode calls to the 3G subsystem is highly debatable.

Moreover, if there are many more calls of a given first type than calls of a second type, that mechanism does not solve the problem of allocating new calls of the first type if the subsystem to which they are usually assigned is saturated.

Moreover, although it is possible to envisage determining an allocation strategy by calculation based on the performance of the subsystems under extreme traffic assumptions, for example if the traffic is virtually non-existent or, on the contrary, if it is intense, it is more difficult to define an allocation strategy based on moderate traffic assumptions, although in reality such assumptions represent the most frequent situation.

One object of the present invention is to alleviate the above drawbacks by proposing an allocation mechanism that takes account of the performance of the subsystems constituting the radio communications system under consideration.

Another object of the invention is to propose an allocation mechanism aimed at handling a large quantity of traffic in the system.

A further object of the invention is to allocate the communications resources of the system with increased flexibility, i.e. without being unduly dependent on the subsystem to which terminals are attached.

A further object of the invention is to define a strategy for allocating communications resources of the various subsystems of the radio communications system that can be applied to a realistic traffic model, without being limited to extreme traffic assumptions.

The invention therefore proposes a method of allocating communications resources in a radio communications system comprising a first subsystem and a second subsystem using different radio access techniques and adapted to communicate with radio terminals. The method comprises the following steps:
determining an indication about the occupancy of the communications resources for at least one of said first and second subsystem,
when a call is to be set up for a radio terminal, allocating at least a communications resource of the first or second subsystem to the call taking into account the indication so determined.

The resources of the radio communications system are therefore allocated in the light of an indication about the use of the communications resources, i.e. of the load on at least some of the subsystems. This avoids overloading certain subsystems compared to others and also has the advantage of optimizing the quality of calls assigned to the subsystem of the radio communications system that, because of its radio access type, offers the best quality under the current load conditions. For example, a TDMA subsystem may be preferred over a CDMA subsystem for a new call if the estimated load on the TDMA subsystem is below a threshold.

The call set-up process, necessitating communications resources of a subsystem of the radio communications system, involves either starting a new call or one subsystem taking over a call that has previously been started on another subsystem.

If the radio terminal for which a call is to be set up is attached to a first subsystem and allocating resources in accordance with the invention entails a second subsystem handling the call, the radio terminal is advantageously assigned to the second subsystem before setting up the call. This may be commanded on the mobile terminal or it may result from broadcast parameter values that favor selection of base stations of the second subsystem.

Resource allocation can also take account of the type of calls to be set up. For example, a packet mode call is assigned on the basis of load considerations, as indicated above, while a circuit mode call is preferably handled by the subsystem to which the radio terminal concerned is attached.

Resource allocation can also take account of the quality of service associated with calls for which resources have been allocated beforehand. It can further take into account the service used for the call to be set up, as a function of the capacities of the various subsystems.

The load to be taken into account, i.e. the indication about the occupancy of the communications resources that has been determined, may be the load on the subsystem to which the terminal is attached and/or that on another subsystem. It may also be an overall load on a portion of the subsystem or a load relating to only a portion of the traffic on that subsystem, for example the load for one given communications mode only. The subsystem to which the terminal is attached advantageously determines its assignment from its own load, which it evaluates for itself, and from the load on the other subsystems, estimates of which are advantageously sent to it.

The invention also proposes a radio communications system adapted to implement the above method and comprising a plurality of subsystems at least some of which use radio access techniques that are different from one another.

Other features and advantages of the present invention become apparent from the following description of non-limiting examples of the invention, which is given with reference to the appended drawings, in which:

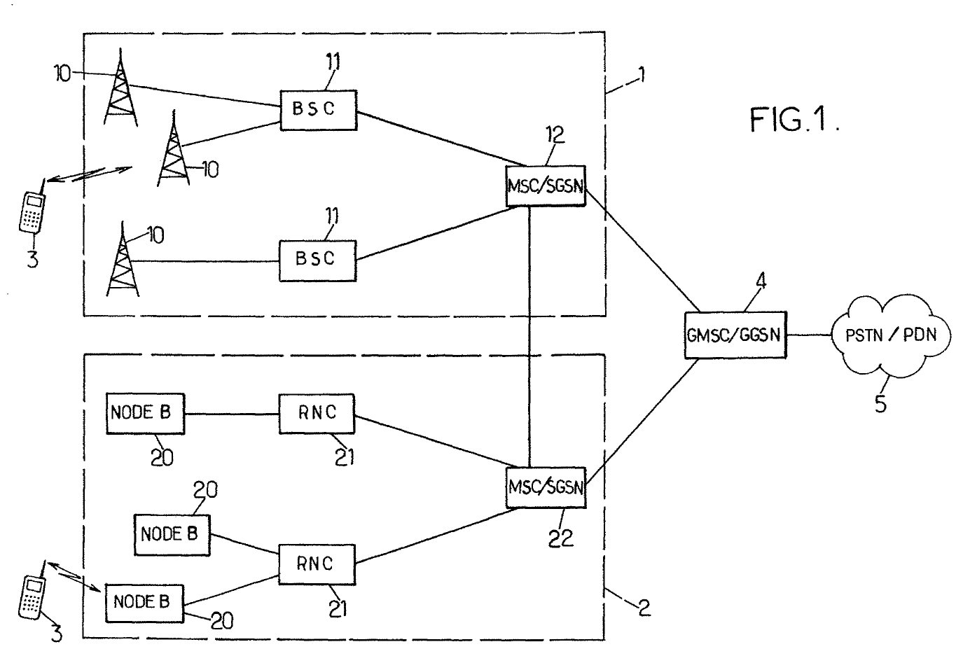

FIG. 1 is a diagram of a simplified heterogeneous radio communications system architecture in which the invention may be used; and

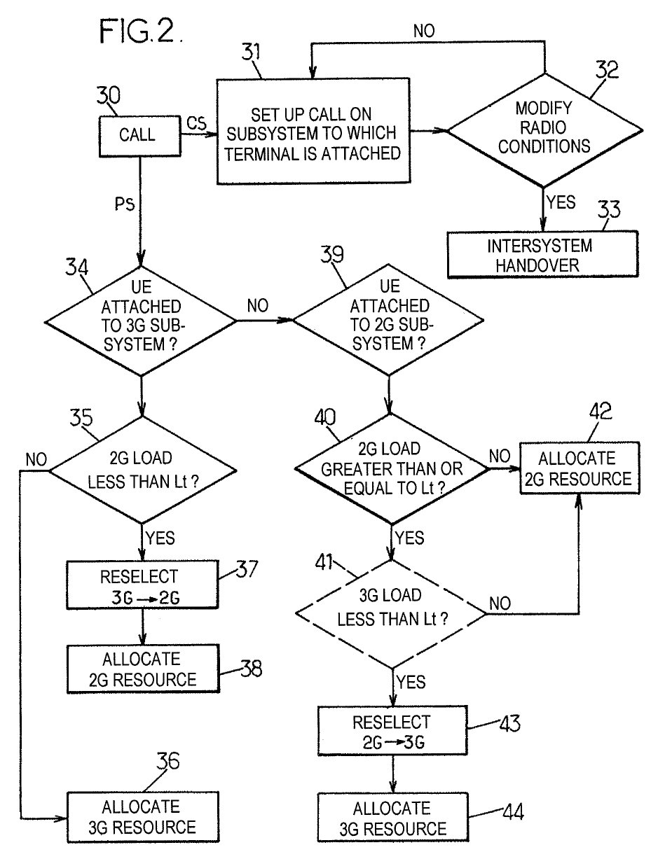

FIG. 2 is a flowchart showing steps of an implementation of a method of the invention.

FIG. 1 represents a heterogeneous telecommunications system comprising a 2.5G radio communications subsystem and a 3G radio communications subsystem. The remainder of the description considers a system of this kind comprising only two subsystems, although the invention applies equally to radio communications systems that comprise more than two subsystems.

The second generation subsystem 1 includes base transceiver stations (BTS) 10 connected to base station controllers (BSC) 11 in turn connected to a core network switch 12 which may be a mobile switching centre (MSC) in a circuit mode communications context or a serving GPRS support node (SGSN) in a packet mode communications context.

The third generation subsystem 2 includes Nodes B 20 serving in particular as base stations and connected to radio network controllers (RNC) 21 in turn connected to a core network switch 22 which may be an MSC or an SGSN.

The core network switches 12 and 22 are connected, possibly via other switches, to a platform 4 that may be a gateway mobile switching centre (GMSC) or a gateway GPRS support node (GGSN) according to whether the core network switches in question are MSC or SGSN. A platform of this kind is used to interconnect the heterogeneous radio communications system and an external network 5, which may be a public switched telephone network (PSTN) in a circuit mode communications context or a packet data network (PDN), for example the Internet.

Radio terminals 3, also known as user equipments (UE), are able to communicate with a remote entity, for example another terminal, via the radio communications system. Either the subsystem 1 or the subsystem 2 may be used for such a communication. Each of the two subsystems of the radio communications system shown uses a different radio access technique. Thus the GSM/GPRS-based subsystem 1 uses the TDMA technique referred to in the introduction and the UMTS-based subsystem 2 uses the CDMA technique referred to in the introduction. As mentioned in the introduction, the frequency spectrum allocated to the subsystem 2 is typically narrower than that allocated to the subsystem 1. However, the spectrum associated with the subsystem 2 could be the same as or even wider than the spectrum associated with the subsystem 1.

The UE 3 support both radio access techniques and are therefore able to exchange information with either of the two subsystems 1 and 2 using the corresponding radio access technique. If a UE 3 is involved in a call via one of the two subsystems 1 and 2, the call may nevertheless continue via the other subsystem, as explained in detail below.

When a UE 3 is not involved in a call, it can be in a mode in which it is completely “cut off” from the radio communications system, meaning that no information or signaling is exchanged between the UE and the system (in the GPRS this mode is called the standby or idle mode), or in an intermediate mode in which the UE receives signals from the radio communications system, carries out measurements, selects a cell covered by a BTS 10 or a Node B 20, and carries out updates in collaboration with the network (in the GSM and the UMTS this mode is called the standby or idle mode and in the GPRS it is called the ready mode). If the UE is in said intermediate mode, which is generally the case before a call involving the UE is set up, it is referred to below as being attached to the subsystem 1 if the last cell selected by the UE, possibly after cell reselection, is covered by a BTS 10 of the subsystem 1, or as attached to the subsystem 2 if the last cell selected by the UE is covered by a Node B 20 of the subsystem 2. When it is attached to one of the two subsystems, the UE can reselect a cell of the other subsystem, as explained in detail below.

When a call is to be set up for a called or calling UE, communications resources, for example one or more time slots in the subsystem 1 or one or more codes in the subsystem 2, are conventionally allocated to the call in the subsystem to which the UE is attached, in particular in the radio part of that subsystem. Thus radio resources are allocated at the base station level, said base station covering the cell that was the subject of the last reselection effected by the UE.

According to the invention, the resources allocated to a call of this kind depend on the occupancy of the resources of the subsystems, i.e. on load values calculated in the radio communications system.

FIG. 2 shows an implementation of the invention. In the step 30, a call request is detected, which means that a call is to be set up for a given UE 3 in collaboration with the FIG. 1 radio communications system. This kind of call may result from an ingoing or outgoing call request involving the UE 3 or from transferring an existing call to new communications resources, in particular if the UE 3 is moving between two coverage areas. In this case, call set-up corresponds to transferring the call to new resources either by a handover procedure or by a cell reselection procedure. In the context of the invention, the expression “call set-up” is therefore to be understood as referring either to starting a call or to transferring a call to new communications resources.

In the implementation shown in FIG. 2, if the UE 3 under consideration and the radio communications system have communications capacity in circuit (CS) mode and in packet (PS) mode, a first analysis is carried out upon completion of the call request detection step 30. Note that this distinction is optional and that it is equally possible to allocate communications resources of the radio communications system by the same method regardless of the transmission mode.

A first alternative is that the detected call request is in CS mode. At this stage, the UE 3 is attached to one of the two subsystems, according to the last cell that it selected by means of a standard cell reselection procedure, as described above. In the implementation shown in FIG. 2, the call is then set up over the subsystem to which the UE 3 is attached (step 31). For example, if the last reselection effected by the UE 3 in standby mode targeted a BTS 10, communications resources of the subsystem 1 are allocated to the CS mode call. In particular, radio resources of the BTS 10 in question are allocated for exchanging communications frames with the UE 3. Conversely, if the last cell that was the subject of a reselection by the UE 3 in standby mode is covered by a Node B 20, the call is set up using communications resources of the subsystem 2. In particular, radio resources of the Node B 20 in question are allocated for exchanging communications frames with the UE 3.

As in the standard situation, mechanisms are available for handing over the call set up in the step 31. These handover mechanisms may hand the call over to new communications resources in the same subsystem (in which case the radio frames are exchanged with a new BTS 10 or a new Node B 20) or resources of the subsystem other than that in which the call was started in the step 31 (this is called intersystem handover). These mechanisms are known in art and are largely based on measurements of radio conditions from the serving base station and adjacent base stations and on the detection of a handover condition (degraded quality of the current radio link, better cell available, etc.) by a unit controlling the serving base station, typically the BSC 11 or the RNC 21. If this kind of handover condition is detected in the step 32, handover (where applicable intersystem handover) may be commanded (step 33). Otherwise, the call proceeds normally on the subsystem to which the terminal is attached.

A second alternative is that the call request detected in step 30 requires operation in packet mode. This typically means transmission of data, for example at the initiative of the UE 3 concerned. The subsystem to which the UE 3 is attached is then determined. It depends on the last cell reselected by the UE. Note that, if the radio communications system does not know the subsystem to which the UE 3 is attached, it can discover it by canvassing (for example paging) the UE. Thus the aim of the step 34 is to determine if the UE 3 is attached to the 3G subsystem (the subsystem 2 in FIG. 2).

If the UE 3 is attached to the 3G subsystem, the load on the subsystem 1 is then verified in the step 35. For simplicity the subsystem 1 is referred to as the “2G subsystem” in the remainder of this specification even if it supports the GPRS, i.e. even if it is in fact a 2.5G subsystem. To this end, the RNC 21 controlling the Node B 20 covering the last cell reselected by the UE 3 stores continuously information relating to the load on the 2G cells of the subsystem 1. If a UE effects a handover from the subsystem 2 to the subsystem 1 (3G→2G handover) in circuit mode, an indication of the handover target cell load may be sent to the source RNC. Such indications may form part of the “New BSS to Old BSS Information” defined in section 3.2.2.80 of the Technical Specification TS 148 008, version 5.10.0, “Mobile Switching Centre-Base Station System (MSC-BSS); Interface Layer 3 Specification”, published in September 2003 by the ETSI (European Telecommunications Standards Institute), for example. Once the indication of the target 2G cell load has been communicated to the MSC/SGSN 22 of the 3G subsystem, the subsystem can then forward the information to the RNC 21, for example in a command to execute the handover (“HO Command”).

Accordingly, the RNC 21 that stores these indications of the load on certain adjacent cells of the 2G subsystem can deduce therefrom a local 2G subsystem load. It then compares the load value obtained in this way with a threshold value Lt that is advantageously selected to optimize the performance of the radio communications system. In this implementation, data transmission quality is deemed to be better when the data is transported by a TDMA subsystem provided that the load on the subsystem concerned has not reached a load value Lt. Beyond that value, transmission quality will be higher if the data is transported by a CDMA subsystem. The value of Lt is preferably calculated beforehand by simulation and may be adjusted on the basis of an analysis of the performance actually obtained in each of the two subsystems.

Accordingly, if, during the step 35, the estimated 2G load is greater than the load value Lt, the first priority is to use the CDMA technology 3G subsystem for the call and 3 G communications resources are therefore allocated to the call (step 36). Those resources include inter alia codes at the radio interface between the UE 3 and the Node B 20 covering the cell most recently reselected.

In contrast, if the 2G load estimated by the RNC 21 is less than the load value Lt, then setting up the PS call on the 2G subsystem is attempted. As the UE 3 is attached to the 3G subsystem, a cell of the 2G subsystem must be reselected before setting up the call to ensure that 2G resources are allocated to the call (step 37). This kind of 3G→2G reselection can conform to the procedure described in section 8.3.11 of the Technical Specification TS 125 331, version 5.6.0, “Universal Mobile Telecommunications System (UMTS); Radio Resource Control (RRC) protocol specification”, published in September 2003 by the ETSI. When a cell of the 2G subsystem has been reselected by the UE at the command of the radio access network of the 3G subsystem, 2G resources can be allocated to the call. In particular, radio resources in the form of time slots on one or more carrier frequencies are allocated for exchanging data between the BTS 10 covering the newly-selected cell and the UE 3 (step 38).

The estimated 2G load may optionally also be compared to a second load threshold selected so that the 2G subsystem is not overloaded for no good reason. Accordingly, if the 2G load has reached or exceeded a critical load threshold of this kind, the first priority is to allocate resources of the 3G subsystem to the new call, even if the 2G load is below the threshold value Lt. This avoids blocking phenomena on the 2G subsystem that would otherwise limit the overall capacity of the radio communications system.

If the UE 3 under consideration is not attached to the 3G subsystem, it follows that it is attached to the 2G subsystem (step 39). As before, an indication of the load on the 2G subsystem is then estimated in order to set up the call on the 2G subsystem if the load is below the threshold or on the 3G subsystem otherwise.

A 2G load is therefore estimated in the step 40. This estimation may be effected in the 2G subsystem, for example using event counters that may be incremented on the basis of a cell or a group of cells. To obtain pertinent 2G subsystem load information, it is advantageous to take account of cumulative information for a significant number of cells obtained by adding the counter values obtained for each cell or group of cells.

To this end, an estimate of the overall 2G load is advantageously used, i.e. the load for all the available communications modes, and in CS mode and in PS mode in particular, given that an adaptation mechanism may be used in the 2G subsystem to dynamically reserve relative proportions of the resources for CS traffic and for PS traffic as a function of the respective demands.

The CS traffic load on the 2G subsystem is deduced from the number of communications resource requests over an observation period, for example. The following indicators may be deduced for the PS traffic load on the 2G subsystem, for example: the number of call contexts (PDP contexts) activated, the number of abnormal losses of transmission of data (the number of losses is substantially linked to the number of transmissions of data), the load on the processor of the PCU (packet control unit) for packets transmitted by the GPRS, which may be integrated into a BSC 11, for example (the processor load depends on the occupancy of the communications resources), the fill ratio of a queue of the PCU containing the data units to be transmitted (the greater the load on the 2 G communications resources, the longer the data units remain in the queue), the bit rate offered compared to the bit rate required by each user (an offer matching the demand perfectly indicates low communications resource occupancy), radio channel quality indicators such as the indicator RxQual (radio channel quality being inversely proportional to the level of interference linked to occupancy of the 2G radio channels), the numbers of transmitted and erroneous blocks or frames, or the ratio, calculated in the PCU, of the number of blocks transmitted over the radio interface to the maximum number of blocks that can be transmitted over all the radio resources available for PS traffic (which corresponds to a percentage occupancy of the radio resources). Of course, many indicators other than those cited above may be used to arrive at a pertinent estimate of the load on the 2G subsystem.

In an advantageous implementation of the invention, the indicators used to estimate the 2G load are weighted according to the quality of service of the users involved in certain 2G calls. Accordingly, if the indicator used is a number of blocks transmitted over the radio interface, the blocks transmitted by a user whose subscription guarantees a very high quality of service are counted with a high weighting coefficient, whereas blocks transmitted by a user whose subscription takes no account of quality of service are counted with a low weighting coefficient. In this way, the 2G load is artificially overestimated to prevent too great a flow of new calls to the 2G subsystem, which could degrade the quality of service offered to a level below that which certain users are entitled to expect.

The overall 2G load is then deduced from the load estimates obtained for CS and PS traffic, respectively, for example by adding the two estimates together. If the estimates are not produced by the same equipment, they may be centralized to enable the overall load to be calculated. For example, if the PS traffic load is estimated in a BSC 11 and the CS traffic load is estimated in a PCU, then the PCU advantageously sends its estimate to the BSC 11, which produces the overall 2G load estimate. Note that information relating to the 2G subsystem load sent to the 3G subsystem in the step 35 (see above) may contain the estimate of the 2G load produced in the 2G subsystem, for example, based on the indicators referred to above.

When the 2G load has been estimated, it is compared, in the step 40, to a load threshold Lt which has substantially the same value as the threshold used in the step 35 described above, although using a different value may be envisaged. If the estimated 2G load is below the load value Lt, then 2 G communications resources are used for the new call (step 42). It is then advantageous for the BSC 11 that controls the BTS 10 covering the cell that was most recently reselected by the UE 3 under consideration to compare the 2G load with the threshold value Lt and allocate radio resources for communication between the BTS 10 and the UE 3. This mechanism ensures that the first priority is for new calls to be assigned to the 2G subsystem if its radio resources are not very busy.

In contrast, if the step 40 comparison indicates that the estimated 2G load is greater than or equal to the threshold value Lt, the first priority is to allocate resources of the 3G subsystem to the new call involving the UE 3 concerned. To this end, a 2G→3G reselection is effected. Note that, in contrast to the conventional situation in which the mobile terminal effects cell reselection autonomously, the invention provides for the reselection referred to above to be commanded by the network. In particular, this mode of operation controlled by the network is catered for by broadcasting or sending to the UE concerned the NC2 parameter described in section 10.1.4 of the Technical Specification TS 145 008, version 5.12.0, “Digital cellular telecommunications system (Phase 2+); Radio subsystem link control”, published in August 2003 by the ETSI. The 2G subsystem then sends a command to the UE 3 for the UE 3 to reselect a cell under the control of the 3G subsystem (see section 10.1.4.2 of the Technical Specification TS 145 008 cited above). This PACKET CELL CHANGE ORDER command and the intersystem cell reselection mechanism are described in the Technical Specification TS 144 060, version 5.8.0, “Digital cellular telecommunications system (Phase 2+); General Packet Radio Service (GPRS); Mobile Station (MS)-Base Station System (BSS) interface; Radio Link Control/Medium Access Control (RLC/MAC) protocol”, published in September 2003.

When the 2G→3G reselection has been effected, 3 G communications resources are allocated to the call involving the UE 3 concerned (step 44). In particular, 3G radio resources for communication between the Node B 20 covering the cell that was the subject of the 2G→3G reselection and the UE 3 are allocated under the control of an RNC 21.

In an advantageous implementation, the 3G subsystem load may also be estimated before allocating resources to the new call. This implementation includes the optional step 41 indicated in chain-dotted line in FIG. 2. It estimates a 3G subsystem load and compares it to a threshold value. This avoids assigning the new call to the 3G subsystem if said subsystem has already reached a critical load value Lc; the call is instead assigned to the 2G subsystem (step 42), for which the load exceeds Lt, and its quality is therefore less than the optimum.

The 3G load may be estimated in various ways. For example, an RNC 21 estimates the occupancy of the 3G radio resources for handling CS mode traffic and calculates the ratio between the number of data blocks sent in PS mode and a theoretical maximum number of blocks that can be sent in the same observation period. The CS traffic and PS traffic loads can be added together to obtain an overall 3G load estimate. Alternatively, it may be sufficient to estimate the 3G load for only one of the two communications modes. For example, only the PS traffic load is considered if the new call is to be effected in PS mode. This avoids assigning the new data transmission to the 3G subsystem if its resources reserved for PS mode traffic are already largely occupied. Of course, many other indicators may be used to estimate the 3G load. The following indicators for the PS traffic load are cited by way of additional examples, and may be consolidated for a 3G cell or a set of 3G cells (for example all the cells covered by Nodes B 20 under the control of an RNC 21): number of connections between an RNC 21 and a set of UE that were refused, number of radio access operations that failed, number of paging requests that failed, average load on the processor of an RNC and variations thereof, number of codes allocated compared to the number of codes available, percentage of the power used relative to a total available power, etc. As in the 2G situation described above, the 3G load may be weighted to take account of the quality of service associated with the various users making calls on the 3G subsystem.

When a 3G load estimate has been obtained, for example for all the cells supervised by an RNC 21, it is advantageously sent to the BSC 11 controlling the BTS 10 covering the cell most recently reselected by the UE 3 concerned (either directly, if the RNC 21 and the BSC 11 are connected to each other, or via other units, such as the MSC/SGSN 12 and 22, or even the GMSC/GGSN 4). The BSC 11 in question can therefore take account of the information relating to the 3G subsystem load and decide to allocate 2G resources to the new call or command the UE to effect 2G→3G reselection, as in the situation described above.

Note that over and above considerations of the load on the subsystems 1 and 2, the first priority is to assign a new PS mode call detected in the step 30 to the 3G subsystem if it corresponds to a service offered only by that subsystem. For example, a call that necessitates transferring a large amount of data in real time (for example for streaming applications) is handled by the 3G subsystem, the 2G subsystem having insufficient capacity to support and control this kind of call. In contrast, if the call relates to a service supported by the 2G subsystem and also by the 3G subsystem, for example one with no real time constraints, it is assigned to one of the two subsystems by the process shown in FIG. 2. Alternatively, there may be a higher priority for a call of this kind to be handled by the 2G subsystem, to leave 3G subsystem resources available for future calls requiring a real time service. The same principle is applied as a function of the bit rate required for the PS mode call detected in the step 30: if that bit rate is greater than the bit rate that the 2G subsystem is able to offer, the call is handled by the 3G subsystem, regardless of the respective loads of the 2G and 3G subsystems.

In the implementation of the invention described above, if intersystem reselection is required before allocating resources of the radio communications system (steps 37 and 43), it is commanded by a radio controller. Accordingly, if the UE 3 concerned is attached to the 2G subsystem, 2G+3G reselection is initiated by the BSC 11 controlling the BTS 10 covering the cell most recently reselected by the UE 3. Conversely, if the UE 3 is attached to the 3G subsystem, 3G→2G reselection is commanded by the RNC 21 controlling the Node B 20 covering the cell most recently reselected by the UE 3.

In another implementation, intersystem reselection may be favored by dynamically setting parameters in the core network of the radio communications system. For example, indicators relating to the load on each subsystem are also available at the MSC/SGSN switches 12 and 22 and the GMSC/GGSN switches. For example, an SGSN counts the number of PS mode call contexts (PDP contexts) activated over an observation period and can therefore deduce an estimate of the occupancy of the resources available in its coverage area, in particular radio resources under the control of the BSC 11 and the RNC 21 connected to it. A finer granularity for estimating the load may even be obtained at the level of the core network. The core network switches generate billing tickets for each cell or group of cells. The load may therefore be estimated for a group of cells of this kind.

The cell reselection algorithm used by a UE calculates one criterion for a serving cell (to which the UE is attached) and a second criterion for adjacent cells, and it is the cell for which the appropriate criterion has the greatest value that is reselected. The criteria in question comprise radio quality measurements relating to the cell and to the adjacent cells, respectively, and also take account of parameters broadcast by the network. Of these parameters, the criterion relating to the serving cell embodies hysteresis to limit the number of successive reselections when the UE is at a boundary between two or more cells. This hysteresis therefore favors retaining the same serving cell. Margins in the criterion relating to adjacent cells favor or penalize independent reselection of each adjacent cell. Finally, a time factor in the expression of the criterion relating to the adjacent cells may also prevent unduly frequent cell reselection.

In this implementation of the invention, the criteria used in the reselection algorithm are modified as a function of the estimated load on the 2G and/or 3G subsystem. For example, in the step 40 in FIG. 2, if the 2G load estimated by the MSC/SGSN 12 or the GMSC/GGSN 4 is greater than or equal to the threshold value Lt, the hysteresis for the serving cell covered by a BTS 10 to which the UE 3 is attached can be reduced to favor reselection, although it is preferable to modify the margins applied to cells adjacent the serving cell to favor cell reselection to a 3G cell covered by a Node B 20, and where applicable by penalizing the adjacent 2G cells covered by other BTS 10. This increases the probability of the UE 3 effecting 2G→3G reselection, corresponding to step 43 in the FIG. 2.

Modifying the parameters cell by cell in this way is advantageously carried out at an operation and maintenance centre (OMC) supervising the radio communications system, which is preferably a combined centre for the 2G and 3G subsystems, either manually by an operator who knows the load estimates produced in the core network or by an automatic script for which load estimates constitute input parameters. The new parameter values are then transmitted on broadcast channels to which all UE listen, so that the UE take account of them.

This method therefore favors intersystem reselection when the load on the 2G and 3G subsystems justifies it and avoids it otherwise. It also has the advantage of allowing the UE to implement the standard cell reselection algorithm autonomously without the radio equipment of the radio communications system requiring additional processing and signaling messages resulting therefrom.

In the implementation of the invention described above and shown in FIG. 2, it has been assumed, based on the observations referred to in the introduction, that new calls should preferably be assigned to a 2G subsystem using a TDMA type radio access technique provided that the subsystem in question is not loaded beyond a certain threshold value and to a 3G subsystem using a CDMA type radio access technique if the 2G subsystem is loaded beyond the threshold value. The threshold value is determined so that the 2G subsystem gives better performance than the 3G subsystem, in terms of communication quality, below it and worse performance than the 3G subsystem above it. The example described above therefore gives priority to assigning a call to the subsystem that would yield the highest possible quality.

However, the present invention is of a more general nature, as it seeks to assign traffic to a given subsystem of a radio communications system comprising a plurality of subsystems as a function of the observed load on at least some of those subsystems. It therefore additionally distributes traffic between the subsystems in a way that limits blocking and failure phenomena, as priority can be given to assigning traffic to a subsystem with a low load. This improves the occupancy of the resources of the overall system.

It is therefore clear that many combinations other than the example shown in FIG. 2 are feasible. For example, in contrast to the FIG. 2 example, it may be envisaged that priority is given first to assigning traffic to the 3G subsystem, for as long as its load is low, and thereafter to the 2G subsystem, if the 3G resources are occupied beyond a load threshold.

Furthermore, the present invention may encompass more than two subsystems, some using different radio access techniques. Various scenarios may then be envisaged, for example by first giving priority to using resources of a first subsystem for as long as its load level is limited, then a second subsystem for as long as its load level is limited, and so on until the resources of the last subsystem are used. When its load exceeds a load threshold, resources of the first subsystem are allocated again, then resources of the second subsystem, and so on. Thus, as in the example shown in FIG. 2, the subsystems are advantageously classified in decreasing order of the communication quality that they offer at low loads, to optimize the quality of new calls, at least for as long as the overall load on the radio communications system remains below a certain limit.

1. A method of allocating communications resources in a radio communications system comprising a first subsystem (1) and a second subsystem (2) using different radio access techniques and adapted to communicate with radio terminals (3), the method comprising the following steps:
determining an indication about the occupancy of the communications resources of said first and/or said second subsystem, and
when a call is to be set up for a radio terminal, allocating a communications resource of the first or second subsystem to the call taking into account the indication so determined.

2. A method according to claim 1, wherein, if the radio terminal for which a call is to be set up is attached to the first subsystem (1) and if taking account of the indication that has been determined implies allocating at least a communications resource of the second subsystem (2) to support the call, an indication is sent to the radio terminal so that it attaches itself to the second subsystem before allocation of the communications resource to the second subsystem.

3. A method according to claim 2, wherein said indication sent to the radio terminal is a message commanding it to attach itself to the second subsystem.

4. A method according to claim 2, wherein the radio terminal is adapted to select a base station (10, 20) of the radio communications system based on selection parameters and measurements effected on radio signals received from a plurality of base stations of the radio communications system and said indication sent to the radio terminal is a broadcast update of at least some of the selection parameters, which are modified to favor the selection of a base station of the second subsystem (2).

5. A method according to claim 1, wherein calls between the radio terminals (3) and the first subsystem (1) or the second subsystem (2) are carried out in packet mode or in circuit mode and a communications resource of the first or second subsystem is allocated to the call taking account of the indication that has been determined only if said call is to be carried out in packet mode.

6. A method according to claim 1, wherein a communications resource of the first subsystem (1) is allocated to the call if the indication relating to the occupancy of the communications resources of the first subsystem reveals an occupancy below a threshold value (Lt) and a resource of the second subsystem (2) is allocated to the call if said indication reveals an occupancy above said threshold value.

7. A method according to claim 6, wherein the threshold value (Lt) is set so that the first subsystem (1) offers better communication quality than the second subsystem (2) if its communications resources are occupied to a level substantially less than said threshold value and worse communication quality than the second subsystem if its communications resources are occupied to a level substantially above said threshold value.

8. A method according to claim 6, wherein, if the radio terminal for which a call is to be set up is attached to the first subsystem (1), a communications resource of the second subsystem (2) is also allocated to the call if the indication relating to the occupancy of the communications resources of the second subsystem reveals an occupancy below a second threshold value (Lc).

9. A method according to claim 1, wherein the radio access technique for said first subsystem (1) or said second subsystem (2) is a code division multiple access (CDMA) technique.

10. A method according to claim 1, wherein the radio access technique for said first subsystem (1) or said second subsystem (2) is a time division multiple access (TDMA) technique.

11. A method according to claim 1, wherein the second subsystem (2) has a substantially narrower frequency spectrum than the first subsystem (1).

12. A method according to claim 1, wherein the indication relating to the occupancy of resources takes into account a quality of service associated with calls for which resources have been allocated.

13. A method according to claim 1, wherein the first subsystem (1) and the second subsystem (2) are each adapted to determine the indication relating to the occupancy of its own communications resources and to obtain the indication that has been determined relating to the occupancy of the communications resources of the other subsystem and whichever of said first and second subsystems to which the radio terminal is attached determines if the communications resource to be allocated to the call is a resource of the first subsystem or the second subsystem.

14. A method according to claim 1, wherein the first subsystem (1) is adapted to communicate with radio terminals (3) for a first set of services and the second subsystem (2) is adapted to communicate with radio terminals (3) for second set of services and allocating a communications resource of the first or second subsystem to the call further takes into account the service provided for said call.

15. A radio communications system adapted to use the method according to any preceding claim and comprising a plurality of subsystems (1, 2), at least some of which use different radio access techniques.
